(19) United States
(12) Patent Application Publication
(10) Pub. No.: US 2013/0026353 A1
(43) Pub. Date: Jan. 31, 2013

(54) Conical Water-Equivalent Phantom Design for Beam Hardening Correction in Preclinical Micro-CT

(71) Applicants: Shikui Yan, Knoxville, TN (US); Junjun Deng, Knoxville, TN (US); Thomas Bruckbauer, Knoxville, TN (US)

(72) Inventors: Shikui Yan, Knoxville, TN (US); Junjun Deng, Knoxville, TN (US); Thomas Bruckbauer, Knoxville, TN (US)

(73) Assignee: SIEMENS MEDICAL SOLUTIONS USA, INC., Malvern, PA (US)

(21) Appl. No.: 13/433,361

(22) Filed: Mar. 29, 2012

Related U.S. Application Data
(60) Provisional application No. 61/512,046, filed on Jul. 27, 2011.

(51) Int. Cl. G01D 18/00

(52) U.S. Cl. 250/252.1

(57) ABSTRACT

Apparatuses, methods, and computer-readable mediums are provided that utilize a phantom to correct attenuation due to beam hardening. The phantom includes a calibration tip attached to a proximal end of a portion. The portion has a diameter that increases incrementally from the proximal end of the portion towards a distal end of the portion (e.g., a substantially conical shape, a substantially convex shape, a substantially concave shape, or a series of adjacent steps). In another embodiment, a method is provided in which the phantom is scanned and an image of the phantom is reconstructed. Thereafter, an x-ray path length and estimated attenuation coefficient are calculated. A sum of expected coefficients are also calculated. The calculations are used to generate an algorithm for beam hardening coefficients.

### CROSS-REFERENCE TO RELATED APPLICATION

This application claims the benefit of U.S. provisional application entitled “A Conical Water-equivalent Phantom Design for Beam Hardening Correction in Preclinical Micro-CT,” filed Jul. 27, 2011, and assigned U.S. Ser. No. 61/512,046, the entire disclosure of which is hereby incorporated by reference.

### BACKGROUND

1. Field of the Invention

Embodiments of the present invention generally relate to a computed tomography and more specifically to phantoms, methods, systems, and computer-readable mediums for beam hardening correction.

2. Description of the Related Art

Microtomography (commonly known as Industrial CT Scanning), like tomography, uses x-rays to create cross-sections of a 3D-object that later can be used to recreate a virtual model without destroying the original model. The term micro is used to indicate that the pixel sizes of the cross-sections are in the micrometer range. These pixel sizes have also resulted in the terminology micro-computed tomography, micro-ct, micro-computer tomography, high resolution x-ray tomography, and similar terminologies. All of these names generally represent the same class of instruments.

In preclinical micro-CT, the dimension (diameter) of the subjects may range from 25 mm (i.e., a mouse sized object) to 60 mm (i.e., a rat sized object). This also means that the machine is much smaller in design compared to the human version and is used to model smaller objects. In general, there are two types of scanner setups. In one setup, the X-ray source and detector are typically stationary during the scan while the sample/small animal (e.g., biomedical samples, foods, microfossils, 3D bone analysis, soft tissue research, insects, microelectronics, materials, geological studies and other studies for which minute detail is desired) rotates. See http://en.wikipedia.org/wiki/Micro-tomography 1/16/2012.

An example of a micro-CT scanner is provided in FIG. 1. FIG. 1 depicts a prior art X-ray micro-CT scanner 100. Specifically, micro-CT scanner 100 includes a fixed X-ray source 102, a fixed flat panel X-ray detector array 104 and a manipulator 116 with a rotator 110 for holding, moving and rotating an object (not shown). The manipulator 106 may be a high precision positioning stage that can move at least in the “X-axis” direction 116, “Y-axis” direction 114, and/or “Z-axis” direction 108. The rotator 110 can rotate about the Z-axis direction 108 for alignment (i.e., to be parallel to) with one dimension of the detector array 104. An X-ray fan beam 112 is generated from the X-ray source 102, passing through the object (not shown) and projecting on the detector array 104.

Another prior art CT scanner 200 is provided in FIG. 2. Specifically, CT scanner 200 includes an x-ray tube 202 having x-ray detectors 204 that move on a track 206 around a patient support table 208. Usually, a yoke (not shown) guides the travel path of the x-ray detector 204 and the x-ray tubes 202. The x-ray detector 204 and x-ray tubes 202 travel in a circular path around the patient support table 208. The yoke (not shown) and the patient support table 208 can move relative to one another along a longitudinal axis 210. The track 206 depicted in FIG. 2 is spiral-shaped in relation to the patient support table 208.

The x-ray detector 204 is preferably a digital flat-panel detector that is made up of a plurality of detector elements 212 (i.e., pixels). The detector elements 212 are preferably arranged in rows 214 and columns 216. Furthermore a readout circuit 218 and an evaluation circuit 220 are connected downstream from the x-ray detector 204. In various embodiments, the evaluation circuit 220 can be a computer. The evaluation circuit 220 includes a correction module 222 that makes image corrections to the image data recorded at the x-ray detector 204. The correction module 222 is followed by a reconstruction module 224, which creates from the projection images a two-dimensional cross-sectional image or three-dimensional volume images of the examined patient. After processing by the reconstruction module 224, an image processing module 226 processes the cross-sectional images or volume images delivered by the reconstruction module 226 for viewing on a monitor 228.

The x-ray tubes 202 are controlled by the evaluation unit 220. Also connected to the evaluation unit 220 are input devices, such as a keyboard 230 or a mouse 232, with which the evaluation unit 220 and thereby the computer tomography device 200 can be controlled.

The x-ray detector 204 detects the x-ray radiation emitted by the x-ray tubes 202 corresponding to a beam of radiation 234. Accordingly projection images are recorded of the patient located on the patient support table 208. For the reconstruction of a volume image or of a cross-sectional image it is necessary to record projection images of the patient from a plurality of projection directions.

Images acquired from the scanners depicted in FIGS. 1 and 2 can suffer from “beam hardening.” Beam hardening is a general problem in high-energy imaging. The absorption of different materials varies with wavelength, but the X-ray detectors normally used are not spectrally sensitive. That is, when bone (or other dense material) is exposed to X-rays, a higher fraction of the lower-energy X-ray photons will be absorbed than of the higher-energy X-ray photons.

A reconstruction algorithm can underestimate the density of the region imaged, because the transmitted high-energy photons will mask the fact that a very high percentage of the lower-energy photons have been absorbed or scattered. Thus, failure to correct for beam hardening effects may cause incorrect estimation of material densities. This is particularly a problem when imaging high-density materials, such as bone.

While the x-ray photons generated by the x-ray source are polychromatic, reconstruction algorithms usually assume the attenuation coefficient of the material is invariant with the energy of the incident photons, thus creating the artifacts and leading to degraded image quality in the reconstructed images. A standard correction algorithm uses a polynomial to perform the beam hardening correction (“BHC”) and requires scanning multiple phantoms of different sizes to obtain the necessary coefficients. Typically, a scan is performed using a thin sheet phantom and another scan is performed using a larger phantom. Further, the size of the phantom limits the range of coefficients that can be used (and the size of a subsequent object that would utilize those coefficients).

Phantoms have been used to calibrate X-ray computed tomography devices using materials of known density. However, these phantoms are typically made of plastic/polystyrene (and filled with water (water is typically used as a reference)). Sometimes the correction algorithm does not adequately account for the phantom material.

Thus, there is a need for a phantom which requires fewer scans and that provides a greater range of coefficients for correcting errors produced from a high-energy scanning device such as an X-ray computed tomography scanner.

### SUMMARY

Embodiments of the present invention generally relate to a computed tomography and more specifically to phantoms, methods, systems, and computer-readable mediums for beam hardening correction. For example, in one embodiment of the invention a phantom is provided that includes a calibration tip attached to a proximal end of a portion. The portion has a diameter that increases incrementally from the proximal end of the portion towards a distal end of the portion. The portion can have various shapes that satisfy this condition (e.g., a substantially conical shape, a substantially convex shape, a substantially concave shape, or a series of adjacent steps).

In another embodiment of the invention, a method is provided in which the above phantom is scanned and an image of the phantom is reconstructed. Thereafter, an x-ray path length and estimated attenuation coefficient are calculated. A sum of expected coefficients are also calculated. The calculations are used to generate an algorithm for beam hardening coefficients (“BHCs”). In various other embodiments the method also optionally includes reconstructing an image using the BHCs and plotting an axial profile of the phantom.

Other embodiments of the invention are provided that include computer-readable mediums having features similar to the methods described herein.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a prior art X-ray micro-CT scanner;

FIG. 2 depicts a prior art CT scanner;

FIG. 3 depicts an exemplary phantom in accordance with aspects of the disclosure;

FIG. 4 depicts an axial view of the exemplary phantom of FIG. 3 in accordance with aspects of the disclosure;

FIG. 5 depicts a cross-sectional view of the exemplary phantom of FIG. 3 in accordance with aspects of the disclosure;

FIG. 6 depicts an axial view of another exemplary phantom in accordance with aspects of the disclosure;

FIG. 7 depicts an axial view of yet another exemplary phantom in accordance with aspects of the disclosure;

FIG. 8 depicts an axial view of still another exemplary phantom in accordance with aspects of the disclosure;

FIG. 9 depicts an axial view of another exemplary phantom in accordance with aspects of the disclosure;

FIG. 10 depicts an embodiment of a graph in accordance with aspects of the disclosure;

FIG. 11 depicts an embodiment of a method in accordance with aspects of the disclosure;

FIG. 12 depicts an embodiment of a method in accordance with aspects of the disclosure; and

FIG. 13 depicts an embodiment of a high-level block diagram of a computer architecture used in accordance with aspects disclosed herein.

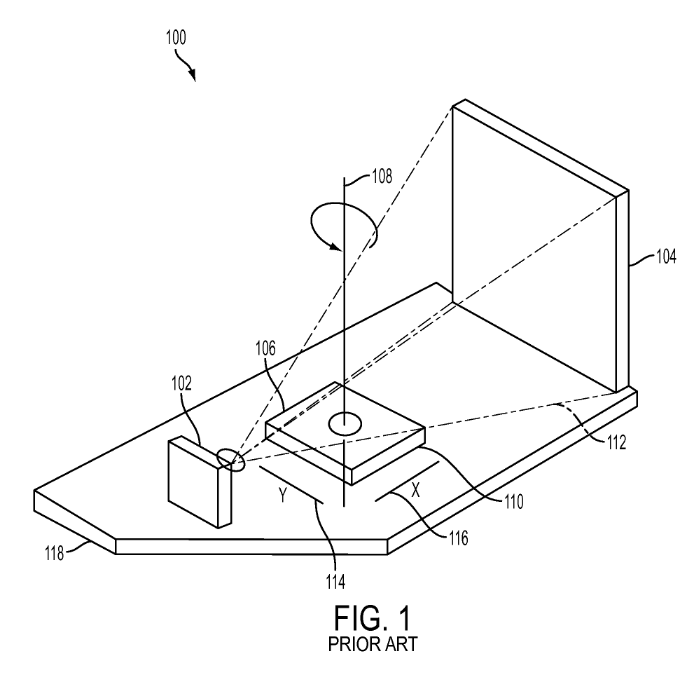

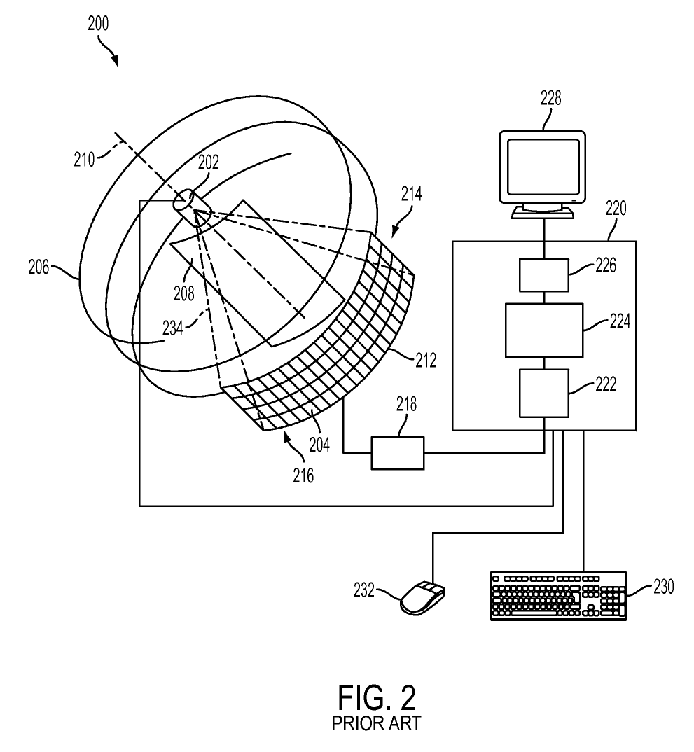

To facilitate understanding, identical reference numerals have been used, wherever possible, to designate identical elements that are common to the figures.

### DETAILED DESCRIPTION

In the following description, numerous specific details are set forth to provide a more thorough understanding of the invention. As will be apparent to those skilled in the art, however, various changes using different configurations may be made without departing from the scope of the invention. In other instances, well-known features have not been described in order to avoid obscuring the invention. Thus, the invention is not considered limited to the particular illustrative embodiments shown in the specification and all such alternate embodiments are intended to be included in the scope of the appended claims.

Embodiments of the invention, as disclosed herein, can be used with various imaging systems. For example, although embodiments of the invention are described herein as being used in conjunction with a micro-computed tomography (“micro-CT”) system those descriptions are for illustrative purposes only and not intended in any way to limit the scope of the invention. Embodiments of the calibration phantom, materials, computer-readable mediums, and methods of the present invention are suitable for use in both micro-CT systems and computed tomography (“CT”) systems. Various embodiments of the invention can be used with other imaging modalities/systems.

Embodiments of the invention provide easy handling and preparation for the acquisition of beam hardening coefficients (“BHC”) for a greater range of differently sized objects. Embodiments of the invention, utilize a phantom made of a water equivalent resin (or “CT solid water”), which improves the calibration accuracy without introducing medium discontinuity on the container walls of the traditional phantoms. For example, resins (e.g., CT-water phantom and CT solid water) that can be used with embodiments of the invention are provided by GAMMEX, INC.© with headquarters in Middleton, Wis.

Embodiments of the invention can be made in various ways. For example, by machining a block of the CT-water phantom or CT solid water into a phantom having a calibration tip (described below) and a portion where the diameter of the phantom increases moving (along the longitudinal axis) in a direction which extends away from the calibration tip.

For illustrative purposes, embodiments of the invention are described below which include a calibration tip and a portion that is conically shaped (described below). However, those depictions are not intended to limit the scope of the invention in any way. For example, embodiments of the invention include a calibration tip and a portion that has a diameter that increases moving in a direction substantially parallel to the longitudinal axis of the phantom.

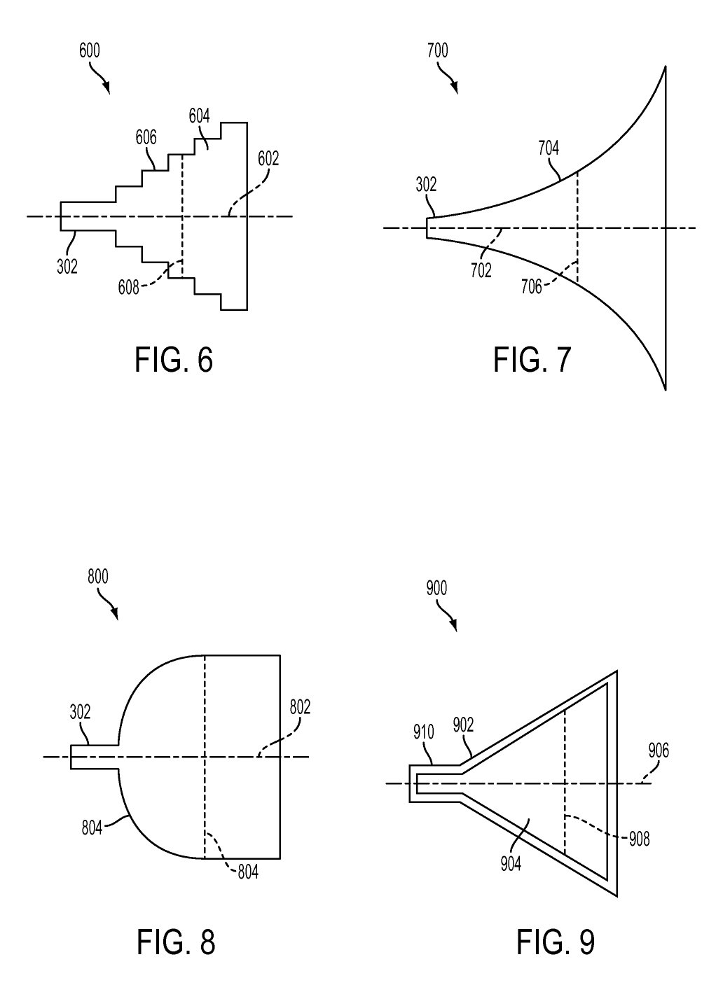

For illustrative purposes only, various exemplary shapes are included. For example, FIGS. 6-9 depict phantoms having a calibration tip and a portion that has a diameter that incrementally increases moving in a direction substantially parallel to the longitudinal axis of the phantom. However, these exemplary shapes are not intended in any way to limit the scope of the invention.

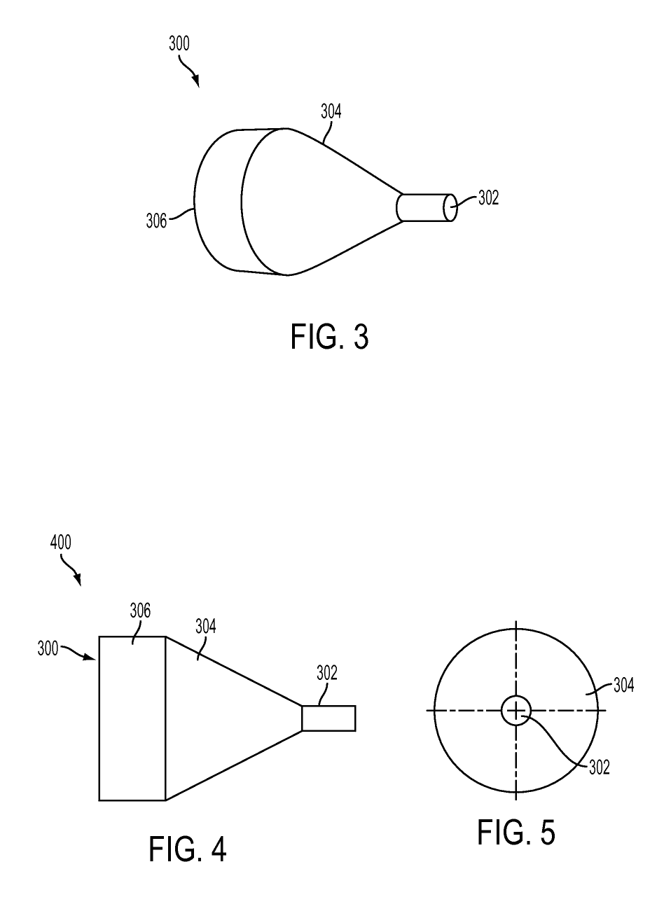

FIG. 3 depicts an illustrative a phantom 300 in accordance with embodiments of the invention. In various embodiments, the phantom 300 is made of a water equivalent resin or “CT solid water.” The phantom 300 includes a calibration tip 302, a substantially conically shaped portion 304, and substantially cylindrically shaped portion 306.

For brevity only, the substantially conically shaped portion 304 is referred to hereinafter as “conical portion 304” and the substantially cylindrically shaped portion 306 is referred to hereinafter as “cylindrical portion 306.” However, neither of these abbreviated references is intended in any way to limit the scope of the invention.

Using the dimensions described herein (and depicted in the Figures) coefficients can be acquired for BHC of subsequently scanned objects that range in size of about a small rodent (e.g. a mouse) to about the size of a large rodent (e.g., a rat). The acquired coefficients can be stored in memory (e.g., in a look-up table) and subsequently used to correct beam hardening of masses of different sizes.

The calibration tip 302 is used to estimate the attenuation coefficient of the phantom 300 under the given polychromatic x-ray spectrum. Experimental data shows the beam hardening effect can be neglected for the calibration tip 302 (because of its small-size). The calibration tip 302 is considered so relatively small that it is considered negligible (i.e., not having the beam hardening artifact) and is used as a reference. In other words, the calibration tip 302 is considered a baseline (or true value). Because of the calibration tip 302 there isn't a need to perform separate scans (i.e., scanning a thin phantom and an additional phantom).

Other embodiments of the invention are described herein, which include a calibration tip. The calibration tip operates substantially the same in each of the described embodiments. For brevity only, further description of the calibration tip is not provided when describing the other embodiments.

The conical portion 304 is used to acquire continuous data of various x-ray path lengths (i.e., to simulate objects of different diameters) in one CT scan. The shape of the conical portion 304 allows acquisition of information for vastly different sizes of objects (i.e., from a size about equal to the size of the calibration tip 302 to a size about equal to the size of the cylindrical portion 306).

The cylindrical portion 306 is used to acquire data for subsequent scans of objects having about the same diameter as the cylindrical portion 306.

Because the phantom 300 is made of water equivalent material (i.e., a water equivalent resin or of CT solid water) the typical complications associated with the prior art phantom walls are avoided. As explained below, the phantom 300 can also be used to quantify and validate BHC algorithms and implementations.

FIG. 4 depicts an axial view 400 of the exemplary phantom 300 in accordance with embodiments of the invention. For illustrative purposes only, FIG. 4 depicts dimensions for the phantom 300. However, the depicted dimensions are not intended in any way to limit the scope of the invention. For illustrative purposes only, the length of the phantom 300 is depicted and described as being about 95 mm; the length of the calibration tip 302 is depicted and described as being about 20 mm; the length of the conical portion 304 is depicted and described as being about 50 mm; and the length of the cylindrical portion 306 is depicted and described as being about 25 mm

It is understood and appreciated that in various embodiments of the invention that the dimensions of the calibration tip 302, conical portion 304, and cylindrical portion 306 are different than the dimensions (i.e., are greater or less than) described herein and depicted in the Figures. It is also understood and appreciated that the size of the calibration tip 302 is sufficient to acquire a baseline value (i.e., having a size not affected by beam hardening).

FIG. 5 depicts a cross-sectional view 500 of the exemplary phantom 300 in accordance with embodiments of the invention. For illustrative purposes only, FIG. 5 depicts the calibration tip 302 as having a diameter of about 10 mm and the conical portion 304 as having a diameter of about 60 mm

FIG. 6 depicts an axial view of another exemplary phantom 600 in accordance with aspects of the disclosure. The phantom 600 includes a longitudinal axis 602 and a diameter 608. A calibration tip 302 forms one portion of the phantom 600. The calibration tip 302 operates as described above. The phantom 600 also includes a portion 604. The portion 604 includes steps 606 that increase in diameter 608 (measured normal to longitudinal axis 602) with each subsequent step (i.e., the diameter of each subsequent step increases) thereby incrementally increasing the diameter of portion 604 of the phantom 600.

FIG. 7 depicts an axial view of yet another exemplary phantom 700 in accordance with aspects of the disclosure. The phantom 700 includes a longitudinal axis 702 and a diameter 706. A calibration tip 302 forms one portion of the phantom 700. The calibration tip 302 operates as described above. The phantom 700 also includes a portion 704. The portion 704 is concave and incrementally increases in diameter 706 (measured normal to longitudinal axis 702) in a direction away from the calibration tip 302.

FIG. 8 depicts an axial view of still another exemplary phantom 800 in accordance with aspects of the disclosure. The phantom 800 includes a longitudinal axis 802 and a diameter 806. A calibration tip 302 forms one portion of the phantom 800. The calibration tip 302 operates as described above. The phantom 800 also includes a portion 804. The portion 804 is convex and incrementally increases in diameter 806 (measured normal to longitudinal axis 802) in a direction away from the calibration tip 302.

Note that although the phantoms 300, 600, 700, and 800 having been described herein (and depicted in FIGS. 3, 6, 7, and 8, respectively) as a solid (i.e., as having no cavity or bubble) that these descriptions and depictions are not intended to limit the scope of the invention in any way. It is appreciated that embodiments of the invention also include phantoms (having a calibration tip and a portion that has an incrementally increasing diameter) having a shell (negligible to the effects of beam hardening) and a cavity receptive to liquid (e.g., distilled water).

For example, FIG. 9 depicts an axial view of another exemplary phantom 900 in accordance with aspects of the disclosure. The phantom 900 is a shell 902 having a cavity 904 therein. Prior to scanning, cavity 904 is filled with a liquid (e.g., distilled water).

The shell 902 has a thickness that is negligible to the effects of beam hardening. The thickness of the shell 902 depends upon the material composition of the shell 902.

The phantom 900 includes a longitudinal axis 906 and a diameter 908 (substantially perpendicular (i.e., normal) to the longitudinal axis 906).

A calibration tip 910 forms one portion of the phantom 900. In various embodiments of the invention, the cavity 904 extends into the interior of the calibration tip 910 (or a portion of the interior of the calibration tip 910).

Another portion 906 of the phantom 900 has a diameter 908 that incrementally increases in a direction away from the calibration tip 302. For illustrative purposes only, portion 906 is depicted as having a conical shape. However, that depiction is not intended to limit the scope of the invention in any way. For example, it is appreciated that in other embodiments of the invention a phantom 900 having a shell 902 and cavity 904 therein which includes a portion 906 can have other shapes where the diameter incrementally increases in a direction away from the calibration tip 302. For example, in various embodiments of the invention, the phantom 900 can have shapes similar to the phantoms 600, 700, and 800 depicted in FIGS. 6, 7, and 8, respectively.

In various embodiments of the invention, the phantoms 600, 700, 800, and 900 (depicted in Figures, 6, 7, 8, and 9, respectively) have a total length of about 95 mm and a calibration tip 302 length of about 20 mm. However, it is appreciated that yet other embodiments of the invention include phantoms having different dimensions.

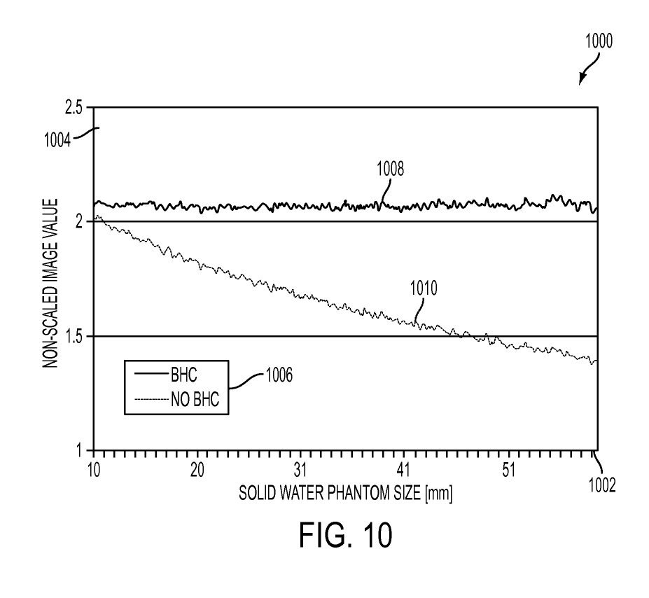

FIG. 10 depicts a graph 1000 in accordance with embodiments of the invention. The graph 1000 includes an Abscissa 1002 that delineates a “Solid Water Phantom Size” in millimeters, an Ordinate axis 1004 that delineates a “Non-scaled Image Value” (i.e., arbitrary units (“A.U.”) and a legend 1006.

Graph 1000 demonstrates that the phantom 300 can be used to verify the corrective effects of the BHCs. Graph 1000 shows axial profiles of images without using BHC 1010 and using BHC 1008 (no scaling to HU is applied). The image value without BHC 1010 changes about 46% (i.e., from about 2.02 at 10 mm to about 1.38 at 60 mm) After performing BHC with phantom 300, a set of coefficients is generated for the current source and filter settings. Except for statistical noise, non-scaled image values are shown to be about constant when changes in the size of the phantom 300 are from about 10 mm to about 60 mm. Applying BHC with using the phantom 300 and the coefficients derived therefrom removes the size-dependent BHC for CT (e.g., micro-CT).

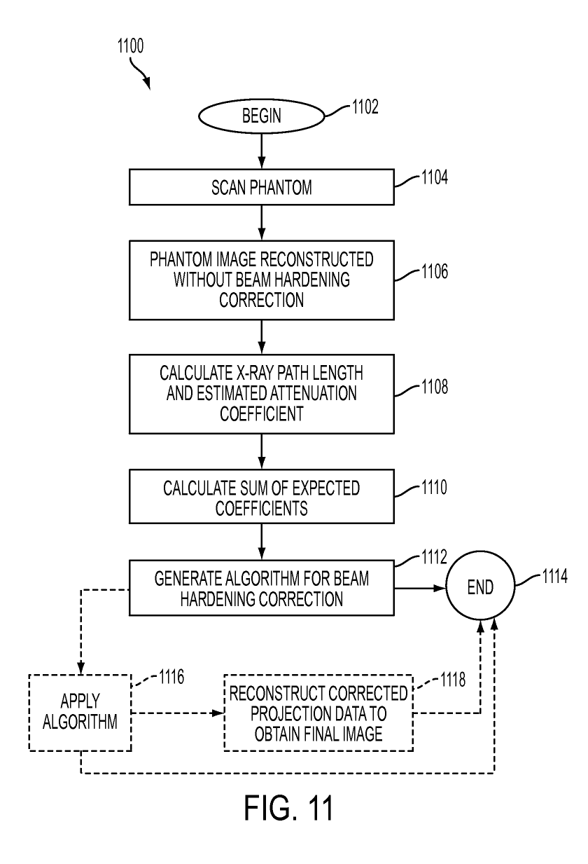

FIG. 11 depicts an illustrative method 1100 in accordance with embodiments of the invention. For illustrative purposes only, method 1100 is described using phantom 300. However, this illustration is not intended to limit the scope of the invention in any way. The method 1100 begins at step 1102 and proceeds to step 1104.

At step 1104, phantom 300 is scanned by a CT system (e.g., a micro-Ct system or other CT system). X-ray projection data is acquired from the scanned phantom 300 to perform a calibration measurement. The entire phantom 300 (i.e., the calibration tip 302, conical portion 304, and cylindrical portion 306) is within the field of view (“FOV”) of the scanner. After scanning, the method 1100 proceeds to step 1106.

At step 1106, an image of the phantom 300 is reconstructed without any BHC and a threshold is applied to retrieve the region of the phantom 300. The threshold is any value that be used to distinguish the phantom from air (i.e., to determine what is the phantom and what is outside of the phantom). For example, about 0.5 can be used as the threshold. Thereafter, the phantom 300 is removed and the method 1100 proceeds to step 1108.

At step 1108, the x-ray path length for each view is calculated by forward-projection and an attenuation coefficient is estimated using the calibration tip 302. Thereafter, the method 1100 proceeds to step 1110.

At step 1110, the x-ray path length and estimated attenuation coefficient are used to calculate the sum of the expected attenuation coefficients along the x-ray path. Thereafter, the method 1100 proceeds to step 1112.

At step 1112, the estimated attenuation coefficients and expected attenuation coefficients are used generate an algorithm (e.g., a third degree polynomial) for correction of artifacts due to beam hardening. Thereafter, the method 1100 proceeds to and ends at 1114.

In various embodiments, after step 1112 (and before proceeding to step 1114) the method 1100 proceeds to optional step 1116. When newly acquired projection data (from an object) needs BHC, optional step 1116 is utilized. At optional step 1116, the algorithm (e.g., the third degree polynomial) generated in step 1112 is applied as a preprocessing procedure to data measured from the object. The algorithm corrects the measured projection data due to beam hardening.

In various embodiments, after optional step 1116, the method 1100 proceeds to and ends at step 1114. However, in other embodiments, after optional step 1116, the method 1100 proceeds to optional step 1118.

At optional step 1118, corrected projection data are reconstructed to obtain a final image. Thereafter, the method 1100 proceeds to and ends at step 1114.

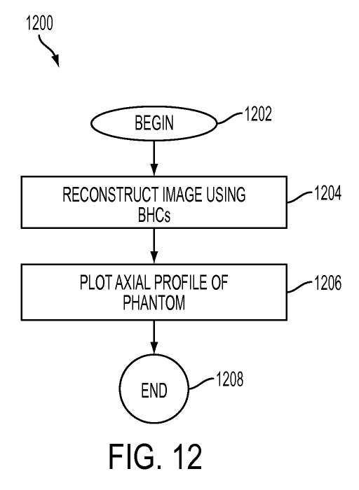

FIG. 12 depicts an illustrative method 1200 in accordance with embodiments of the invention. Specifically, the method 1200 is an exemplary method to validate BHCs. For illustrative purposes only, method 1100 is described using phantom 300. However, this illustration is not intended to limit the scope of the invention in any way. The method 1200 begins at step 1202 and proceeds to step 1204.

At step 1204, BHCs are generated using the phantom 300 and a subsequently scanned object. Thereafter, the method 1200 proceeds to step 1206.

At step 1206, the BHCs, along the axial profile (i.e., from the calibration tip 302 to the cylindrical portion 306) of the phantom 300, are plotted. Plotting the BHCs allows an easy visual inspection of the flatness (aside from some other type of noise) of the BHCs as the diameter size changes continuously from about 10 mm to about 60 mm An example of a substantially flat plot is provided by plot 1008 in FIG. 10.

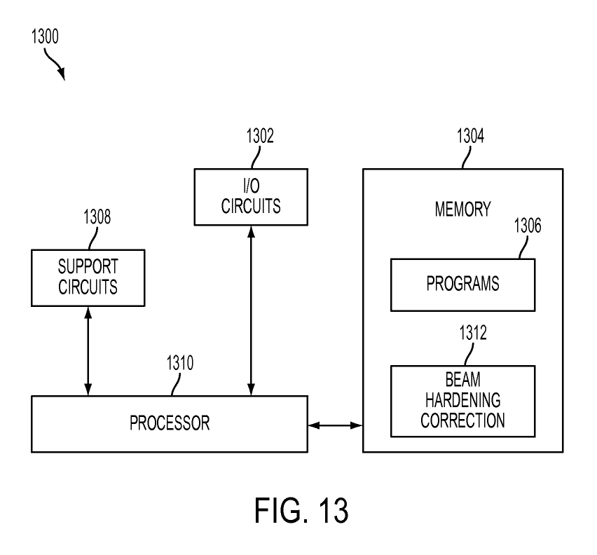

FIG. 13 depicts an embodiment of a high-level block diagram of a general-purpose computer architecture 1300 for generating BHC coefficients in accordance with some embodiments of the invention and validation of BHC coefficients in accordance other embodiments of the invention. For example, the general-purpose computer 1300 is suitable for use in performing the methods 1100 and 1200 (depicted in FIGS. 11 and 12, respectively). The general-purpose computer of FIG. 13 includes a processor 1310 as well as a memory 1304 for storing control programs and the like. In various embodiments, memory 1304 also includes programs (e.g., depicted as a “Beam Hardening Correction” 1312 for providing BHCs and validation of BHCs utilizing a phantom (e.g., phantoms 300, 600, 700, 800, and 900) which includes the calibration tip 302 for performing the embodiments described herein. The processor 1310 cooperates with conventional support circuitry 1308 such as power supplies, clock circuits, cache memory and the like as well as circuits that assist in executing the software routines 1306 stored in the memory 1304. As such, it is contemplated that some of the process steps discussed herein as software processes can be loaded from a storage device (e.g., an optical drive, floppy drive, disk drive, etc.) and implemented within the memory 1304 and operated by the processor 1310. Thus, various steps and methods of the present invention can be stored on a computer readable medium. The general-purpose computer 1300 also contains input-output circuitry 1302 that forms an interface between the various functional elements communicating with the general-purpose computer 1300.

Although FIG. 13 depicts a general-purpose computer 1300 that is programmed to perform various control functions in accordance with the present invention, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein. In addition, although one general-purpose computer 900 is depicted, that depiction is for brevity on. It is appreciated that each of the methods described herein can be utilized in separate computers.

Although the phantom 300 has been described above (and depicted in the Figures) as ranging in size from about 10 mm to about 60 mm, those descriptions and depictions are for illustrative purposes only and not intended in any way to limit the scope of the invention.

For example, in other embodiments of the invention, the diameter of the calibration tip 302 is greater than or less than about 10 mm. In further embodiments, the length of the calibration tip 302 is longer or shorter than about 20 mm It is appreciated that, in accordance with embodiments of the invention, the size of the calibration tip 302 can be any size that is negligible (i.e., not affected by beam hardening).

In addition, it is also appreciated that, in various embodiments, the dimensions of conical portion 304, portion 604, portion 704, portion 804, and portion 906 (i.e., the axial length and circumference of the conical portion 304, portion 604, portion 704, portion 804, and portion 906) are greater or less than 50 mm in length and 60 mm in circumference.

While the foregoing is directed to embodiments of the present invention, other and further embodiments of the invention may be devised without departing from the basic scope thereof, and the scope thereof is determined by the claims that follow.

1. A phantom comprising:
a calibration tip having a proximal end and a distal end; and
a portion having a proximal end and a distal end wherein said proximal end of said portion is attached to said distal end of said calibration tip, said portion has a diameter that increases incrementally from said proximal end of said portion towards said distal end of said portion.

2. The phantom of claim 1 wherein said portion has one of a substantially conical shape, a substantially convex shape, and a substantially concave shape.

3. The phantom of claim 2 further comprising a substantially cylindrical shaped portion coupled to said distal end of said portion.

4. The phantom of claim 3 wherein said calibration tip and said portion are made from one of a water equivalent resin and a CT solid water material.

5. The phantom of claim 1 wherein said calibration tip is about 20 mm long and about 10 mm in diameter.

6. The phantom of claim 1 wherein said portion is about 50 mm long and about 60 mm in diameter.

7. The phantom of claim 3 wherein said substantially cylindrical shaped portion is about 25 mm long and about 60 mm in diameter.

8. The phantom of claim 1 wherein said portion includes a plurality of adjacent steps.

9. The phantom of claim 1 wherein said calibration tip and said portion are a shell wherein effects of beam hardening attenuation are negligible on said shell.

10. The phantom of claim 1 wherein effects of beam hardening attenuation are negligible on said calibration tip.

11. A method comprising:
scanning a phantom, wherein said phantom comprises a calibration tip and a portion having a proximal end and a distal end wherein said proximal end of said portion is attached to said distal end of said calibration tip, said portion has a diameter that increases incrementally from said proximal end of said portion towards said distal end of said portion;
reconstructing an image of said phantom;
calculating an x-ray path length and estimated attenuation coefficient;
calculating a sum of expected coefficients; and
generating an algorithm for beam hardening coefficients.

12. The method of claim 11 further comprising applying said algorithm to subsequently scanned image data.

13. The method of claim 12 further comprising reconstructing corrected projection data to obtain a final image.

14. The method of claim 11 wherein said portion has one of a substantially conical shape, a substantially convex shape, and a substantially concave shape.

15. The method of claim 11 wherein said portion includes a plurality of adjacent steps.

16. The method of claim 11 wherein said phantom is made from one of a water equivalent resin and a CT solid water material.

17. The method of claim 11 further comprising:
reconstructing an image using beam hardening coefficients; and
plotting an axial profile of a said phantom.

18. A computer-readable medium having stored thereon a plurality of instructions, the plurality of instructions, when executed by a processor, cause the processor to generate an actuator comprising the steps of:
scanning a phantom, wherein said phantom comprises a calibration tip and a portion having a proximal end and a distal end wherein said proximal end of said portion is attached to said distal end of said calibration tip, said portion has a diameter that increases incrementally from said proximal end of said portion towards said distal end of said portion;
reconstructing an image of said phantom;
calculating an x-ray path length and estimated attenuation coefficient;
calculating a sum of expected coefficients; and
generating an algorithm for beam hardening coefficients.

19. The computer-readable medium of claim 18 further comprising:
reconstructing an image using beam hardening coefficients; and
plotting an axial profile of a said phantom.

20. The computer-readable medium of claim 18 further comprising applying said algorithm to subsequently scanned image data.

21. The computer-readable medium 20 further comprising reconstructing corrected projection data to obtain a final image.

22. The computer-readable medium of claim 18 wherein said portion has one of a substantially conical shape, a substantially convex shape, and a substantially concave shape.

23. The computer-readable medium of claim 18 wherein said portion includes a plurality of adjacent steps.
